(19) United States
(12) Patent Application Publication
(10) Pub. No.: US 2003/0031240 A1
(43) Pub. Date: Feb. 13, 2003

(54) Downstream only suspend-type Q-Mode

(76) Inventors: Arthur J. Redfern, Plano, TX (US); Benjamin Wiseman, Palo Alto, CA (US)

Correspondence Address: TEXAS INSTRUMENTS INCORPORATED, P O BOX 655474, M/S 3999, DALLAS, TX, 75265

(21) Appl. No.: 10/174,078

(22) Filed: Jun. 18, 2002

Related U.S. Application Data
(60) Provisional application No. 60/309,092, filed on Jul. 31, 2001.
(60) Provisional application No. 60/331,218, filed on Nov. 13, 2001.

(51) Int. Cl. H04B 1/38

(52) U.S. Cl. 375/222

(57) ABSTRACT

A method of providing downstream suspend type Q-mode for ADSL between a central office (CO) modem and consumer premise equipment (CPE) modem is presented. Q-mode allows for transmitter power savings while at the same time minimizes the generation of time-varying crosstalk. During the initialization stage the CO transmits a pair of messages wherein the first message informs the CPE of a power cutback level and the second message indicates a signal point for each subchannel from which is formed the Q-mode signal Q. The CO sends the CPE the maximum and minimum number of frames for exit and the CPE chooses a number of frames within those limits. The system enters the Q-mode by the CO sending a Q-mode enter signal. The system exits the Q-mode by the CO sending an exit signal. During Q-mode, all high modem layers are frozen, and upon exit are restarted.

### FIELD OF INVENTION

This invention relates to discrete multitone (DMT) modems such as asymmetric digital subscriber line (ADSL) modems and more particularly to a power conserving state known as Quiescent mode (Q-Mode).

### BACKGROUND OF INVENTION

ADSL modems employing DMT modulation are used for internet access. The ADSL standard is described in S. Palm (ed.), “Asymmetrical Digital Subscriber Line (ADSL) Transceivers,” ITU-T Q4/SG15, G.992.1,1999. This reference is incorporated herein by reference.

Q-mode is a proposed power conserving idle state that an ADSL modem can enter when it has no data to transmit. Initial proposals for Q-mode used a suspend-type approach, where all of the clocks, registers, interleavers, states, etc. in the higher layers are frozen upon entry into Q-mode, and restarted upon exit. Due to concerns that missing an entry or exit signal will result in a retrain, a free running approach was proposed which allows for re-synchronization between transmitter and receiver if a message was missed. The drawback to the free-running approach is the need to modify all of the Transmission Convergence (TC) layers to generate an all zero sequence when there is no data to transmit. This results in additional coupling between the physical and TC layers which would be desirable to avoid.

With respect to the Q-mode signal, a number of proposals have been made as to its content. The two basic trends that have emerged are that the transmitter should be allowed to choose its own Q-mode signal (within limits) that maximizes power reduction, and the Q-mode signal should not vary in power significantly from a Showtime (normal data) signal (to prevent the generation of time-varying crosstalk).

### SUMMARY OF INVENTION

In accordance with one embodiment of the present invention a suspend-type Q-mode is provided for the downstream direction. This allows for a simple method of power reduction with flexibility in entry, exit, and Q-mode signal design. Entry into Q-mode is negotiated, and the exit is signaled. The flexibility in exit signaling allows for a tradeoff between robustness to impulsive noise and speed and memory requirements. During Q-mode, all higher modem layers are frozen, and upon exit they are restarted.

### DESCRIPTION OF DRAWING

FIG. 1 illustrates the messages exchanged during initialization to setup Q-mode;

FIG. 2 illustrates the messages exchanged during Showtime for CO initiated Q-mode entry and exit;

FIG. 3 illustrates the messages exchanged during Showtime for CO initiated Q-mode entry and CPE initiated Q-mode exit;

FIG. 4 illustrates the messages exchanged during Showtime to modify the Q-mode filler signal.

### DESCRIPTION OF PREFERRED EMBODIMENTS OF THE PRESENT INVENTION

Basic Operation

The system of the present invention presents a robust suspend-type Q-mode system which allows for power savings at the central office (CO) while minimizing the modifications required of the higher modem layers. Power savings can be achieved when there is no data available for transmission from the CO modem to the consumer premise equipment (CPE) modem.

Suspend-type Q-mode, according to one embodiment of the present invention, is for the downstream (CO to CPE) direction only. This is to prevent additional complexity in the entry procedure (e.g. one side's entry into Q-mode pulling the other side out of Q-mode), and makes sense from a power saving perspective, as statistical power savings is more appropriate at the CO side while a power down state is more appropriate at the CPE side.

Upon entry into Q-mode, the transmitter and receiver both freeze all of the PMS-TC (Physical Media Specific Transmission Convergence) and TPS-TC (Transport Protocol Specific Transmission Convergence) layer states. Upon exit from Q-mode, these layers resume operations from where things left off (with the next frame to be transmitted being the first frame in the superframe).

The Q-mode Signal

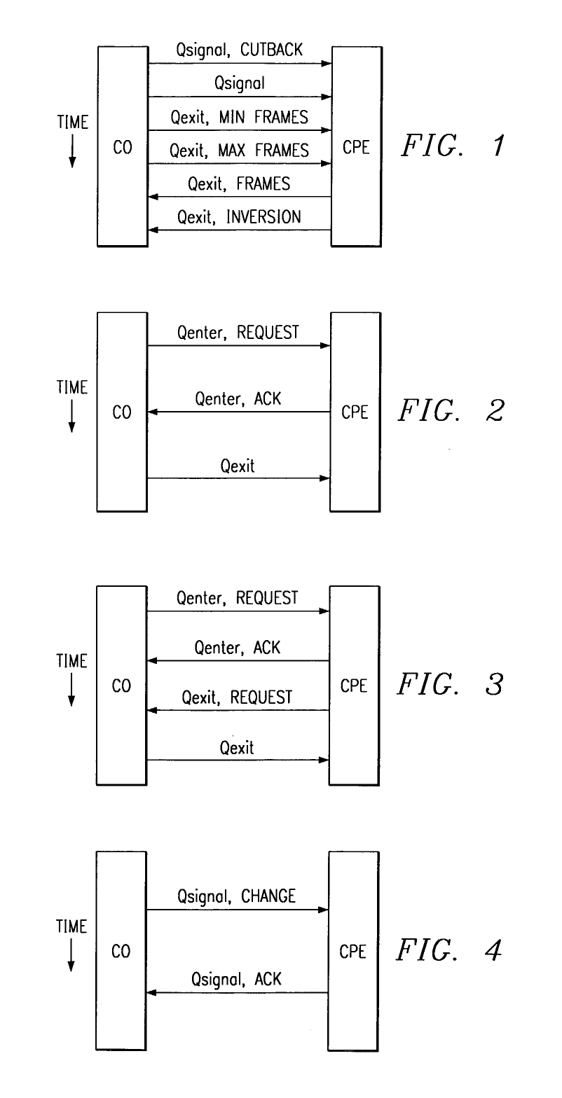

The Q-mode signal, Q, allows for transmitter power savings while at the same time minimizing the generation of time-varying crosstalk. During initialization, after the downstream bits and gains table has been sent to the CO, the CO replies with two messages. The initialization messages are illustrated in FIG. 1 and described in Table 1. The first message informs the CPE of the power cutback level during the Q-mode signal, Q_{signal, cutback}. Q_{signal,cutback} can take on values from 0, . . . , 15, and represents the power level decrease in dB from the Showtime power level. Q_{signal,cutback} can be configured by the operator, with a default value of 0 dB. Table 3 summarizes the Q-mode parameters that can be configured by the operator.

The second message, Q_{signal}, indicates a 4-QAM point for each subchannel. See FIG. 1 and Table 1. The basic Q-mode signal, Q, is formed from Q_{signal} by transmitting the Q_{signal} point for each subchannel with the same gain setting during Showtime. The Q_{signal} bits for subchannels with a gain setting of 0 are not transmitted. The CPE responds with Q_{signal,ack} to acknowledge receiving the Q-mode definition.

During normal Q-mode operation, the CO transmits either Q or Qᵢₙᵥ, depending on the current output of the PRBS (Pseudo-Random Binary Sequence) used for Medley. The PRBS is a useful mechanism for generating a sequence of 1's and 0's. If the PRBS output is 0, then Q is transmitted. If the PRBS output is 1, then Qᵢₙᵥ is transmitted. The PRBS is initialized to the all ones states at the start of each Q-mode entry. Q and Qᵢₙᵥ are transmitted at the nominal Showtime power level reduced by Q_{signal, cutback} dB. Qᵢₙᵥ is the 180 degree inversion of the Q signal.

If the CO determines that it wants to modify the Q-mode signal that it specified during initialization, then it can send a Q_{signal, change} message indicating the subchannel and new Q_{signal} value for that subchannel. The CPE responds with a Q_{signal,ack} message to indicate that it has made the requested change to the Q-mode signal. This is illustrated by FIG. 4 and described in Table 2.

Entry

When the CO determines that it has no data to transmit, it sends a message to the CPE in an overhead channel, Q_{enter,request}, requesting to enter Q-mode. The CPE indicates to the CO that it successfully received the message with Q_{enter,ack}, by inverting the sync symbol. At the next downstream superframe boundary, the CO enters Q-mode and starts to transmit {Q, Qᵢₙᵥ} according to the PRBS. The Q-mode messages that occur at Showtime are illustrated in FIG. 2 and described in Table 2.

There are two configurable parameters which determine how often the CO can enter Q-mode. Q_{entry, delay} is the number of superframes between a Q-mode exit and the next allowed entry attempt. Q_{entry, disable} is the number of superframes to disable Q-mode for if there are more than Q_{exit, failures} exit failures in Q_{exit, attempts} exit attempts. The CO should not attempt to enter Q-mode for the first 512 superframes. These parameters that can be configured by the operator are summarized in Table 3.

Exit (CO Initiated)

CO initiated exit from Q-mode is done when the CO has data to transmit. Conflicting goals of the exit are robustness to impulsive noise and the speed of the exit. The proposed exit procedure allows the CO to request a minimum number of frames for exit (to ensure some robustness to impulsive noise), while at the same time setting an upper limit on the number of frames available for exit (to prevent an unnecessary memory burden or delay).

During initialization, the CO conveys to the CPE the minimum, Q_{exit,min frames}, and maximum, Q_{exit,max frames}, number of frames that it can use to signal an exit. The CPE chooses a number of frames from this range, Q_{exit, frames}, and also selects an inversion pattern, Q_{exit,inversion}, for signaling the exit. The last 8−Q_{exit, frames} bits of the Q_{exit,inversion} are set to 0 by the CPE and are ignored by the CO. For example, if it takes only two frames for exit then the last six (8−2) bits are set to zero. Refer to the initialization messages illustrated in FIG. 1 and described in Table 1.

While in Q-mode, when the CO wishes to signal an exit, it XOR's the next Q_{exit,frames} bits of the PRBS with Q_{exit,inversion} and outputs Q if the result is 0, and −Q if the result is 1. On the Q_{exit,frames}+1th frame, the CO returns to transmitting Showtime data.

To track the recent success rate of the Q-mode operation, the CO records the number of exit failures, Q_{exit,failures}, in the last Q_{exit, attempts}. This can be used with the Q_{entry,disable} to delay or prevent Q-mode operation if it is unstable. Refer to the operator settings in Table 3.

Exit (CPE Initiated)

There are times when the CPE would like a more “random” signal than {Q, −Q } to track variations in the channel and update its various parameters. The CPE can achieve this by sending a Q_{exit, request} message in an overhead channel. Upon receipt of this message, the CO signals to the CPE that it is exiting Q-mode by using the standard CO initiated exit procedure. See FIG. 3 and Table 2.

Messages

Table 1 summarizes the Q-mode messages that occur during initialization after the CPE transmits the downstream bits and gains table to the CO. During initialization the messages occur in the order listed in Table 1. Table 2 summarizes the Q-mode messages that can occur during Showtime. Table 3 summarizes the Q-mode parameters that can be configured by the operator.

TABLE 1
Q-mode messages during initialization

| | | | Allowed | Length in |
|---|---|---|---|---|
| Message | Sender | Purpose | Values | Bits |
| Q_{signal cutback} | CO | Q-mode power level | 0, . . . , 15 | 4 |
| | | cutback in dB | | |
| Q_{signal} | CO | 4-QAM Q-mode | 0, . . . , 3 | 2* |
| | | signal for each | | number of |
| | | subchannel | | sub- |
| | | | | channels |
| Q_{exit, min} | CO | minimum number of | 0, . . . , 8 | 4 |
| frames | | frames to signal | | |
| | | an exit | | |
| Q_{exit, max} | CO | maximum number | 2, . . . , 8 | 4 |
| _{frames} | | of frames to signal | | |
| | | an exit | | |
| Q_{exit, frames} | CPE | number of frames | Q_{exit, min} | 4 |
| | | to signal an exit | frames, . . . , | |
| | | | Q_{exit, max frames} | |
| Q_{exit, inversion} | CPE | inversion pattern | 0, 1 | 8 |
| | | used to signal the | | |
| | | exit | | |

TABLE 2
Showtime Q-mode messages.

| Mes- | | | Message | Length in |
|---|---|---|---|---|
| sage | Sender | Purpose | Format | Frames |
| Q_{enter,} | CO | a request to enter | overhead | — |
| _{request} | | Q-mode | channel | |
| Q_{enter,} | CPE | response to Q_{entry, request} | inverted sync | — |
| _{ack} | | indicating that it's ok to | symbol | |
| | | enter Q-mode | | |
| Qₑₓᵢₜ | CO | exit from Q-mode | inverting some | Q_{exit,} |
| | | | of the {Q,-Q} | frames |
| | | | pattern using | |
| | | | Q_{exit, inversion} | |
| | | | applied to the | |
| | | | PRBS | |
| Q_{exit,} | CPE | a request to exit Q- | overhead | — |
| _{request} | | Mode | channel | |
| Q_{signal,} | CO | a request to change | overhead | — |
| _{change} | | part of the Q-mode | channel | |
| | | signal | | |
| Q_{signal,} | CPE | response to Q_{signal,} | overhead | — |
| _{ack} | | _{change} indicating that | channel | |
| | | it's ok to change the | | |
| | | Q-mode on the | | |
| | | specified subchannel to | | |
| | | the specified value | | |

TABLE 3
Operator configurable Q-mode parameters.

| | | Allowed | Default |
|---|---|---|---|
| Parameter | Purpose | Values | Value |
| Q_{cutback} | power cutback in dB of the Q- | 0, . . . , 15 | 0 |
| | mode signal relative to the | | |
| | Showtime power | | |
| Q_{entry, delay} | superframes between the exit | 0, . . . , 65535 | 0 |
| | of Q-mode and the next | | |
| | allowed entry attempt | | |
| Q_{entry, disable} | number of superframes to | 0, . . . , 65535; 0 | 0 |
| | disable Q-mode for if there | indicate to | |
| | are more than Q_{exit, failures} exit | permanently | |
| | failures in Q_{exit,attempts} exit | disable | |
| | attempts | | |
| Q_{exit, failures} | number of exit failures in the | 0, . . . , 16 | 4 |
| | last Q_{exit, attempts} exit attempts | | |
| Q_{exit, attempts} | number of previous exit | 1, . . . , 16 | 8 |
| | attempts to monitor for | | |
| | success or failure | | |

In the claims:

1. A method of providing downstream suspend type Q-mode for ADSL between a central office (CO) modem and consumer premise equipment (CPE) modem comprising the steps of:
transmitting from the CO to the CPE during Q-mode initialization a signal point for each subchannel from which is formed the Q-mode signal Q,
entering Q-mode by the CO sending a Q-mode enter signal;
transmitting Q or Qᵢₙᵥ , signals depending on the output of a pseudo random binary sequence; and
exiting Q-mode by the CO sending an exit signal.

2. The method of claim 1 including the step of during initialization the CO providing a cutback power level signal for the Q-mode signal during Q-mode.

3. The method of claim 2 including during initialization the steps of the CO providing to the CPE the maximum and minimum number of frames for exit, and the CPE choosing a number of frames within said maximum and minimum number of frames for exit.

4. The method of claim 3 including the step during said initialization of said CPE selecting and sending an inversion pattern for the CO to use to signal an exit from Q-mode.

5. The method of claim 4 including the step of entering into Q-mode by the CO sending an enter Q-mode request signal to the CPE, and the CPE sending an acknowledge signal to the CO.

6. The method of claim 5 wherein the CPE initiates exiting Q-mode by the CPE sending an exit request to the CO.

7. The method of claim 1 including the step of the CO sending a signal to the CPE to indicate a modification to the Q-mode signal, and the CPE sending an acknowledge signal.

8. The method of claim 1 wherein upon entry into Q-mode, the transmitter and receiver both freeze certain transmission convergence layer states and upon exit from Q-mode, these layers resume operations from where they left off.

9. The method of claim 8 wherein said layers are the PMS-TC (Physical Media Specific Transmission Convergence) and TPS-TC (Transport Protocol Specific Transmission Convergence) layers.

10. A method of providing downstream suspend type Q-mode for ADSL between a first transceiver and a second transceiver comprising the steps of:
transmitting from the first transceiver to the second transceiver during Q-mode initialization a signal point for each subchannel from which is formed the Q-mode signal Q,
entering Q-mode by the first transceiver sending a Q-mode enter signal;
transmitting Q or Qᵢₙᵥ, signals depending on the output of a pseudo random binary sequence; and
exiting Q-mode by the first transceiver sending an exit signal.

11. The method of claim 10 including the step of during initialization the first transceiver providing a cutback power level signal for the Q-mode signal during Q-mode.

12. The method of claim 11 including during initialization the steps of the first transceiver providing to the second transceiver the maximum and minimum number of frames for exit, and the second transceiver choosing a number of frames within said maximum and minimum number of frames for exit.

13. The method of claim 12 including the step during said initialization of said second transceiver selecting and sending an inversion pattern for the first transceiver to use to signal an exit from Q-mode.

14. The method of claim 13 including the step of entering into Q-mode by the first transceiver sending an enter Q-mode request signal to the second transceiver, and the second transceiver sending an acknowledge signal to the first transceiver.

15. The method of claim 14 wherein the second transceiver initiates exiting Q-mode by the second transceiver sending an exit request to the first transceiver.

16. The method of claim 10 including the step of the first transceiver sending a signal to the second transceiver to indicate a modification to the Q-mode signal, and the second transceiver sending an acknowledge signal.

17. The method of claim 10 wherein upon entry into Q-mode, the first transceiver and the second transceiver both freeze certain transmission convergence layer states and upon exit from Q-mode, these layers resume operations from where they left off.

18. The method of claim 17 wherein said layers are the PMS-TC (Physical Media Specific Transmission Convergence) and TPS-TC (Transport Protocol Specific Transmission Convergence) layers.

19. A method of providing downstream suspend type Q-mode for ADSL between a first modem and a second modem comprising the steps of:
negotiating entry into the Q-mode between the first modem and said second modem;
entering Q-mode by the first modem sending a Q-mode enter signal;
freezing certain high level modem layers of said first and second modems during Q-mode;
exiting Q-mode by the first modem sending an exit signal; and
restarting said high level modem layers of said first and second modems upon exiting Q-mode.
